(19) United States
(12) Patent Application Publication
(10) Pub. No.: US 2005/0278907 A1
(43) Pub. Date: Dec. 22, 2005

(54) Carabiner

(76) Inventors: Silvio Joseph DiMarchi, Leonia, NJ (US); Lawrence P. Scanzillo, Upper Saddle River, NJ (US); Sheng-Fu Lee, Ramsey, NJ (US); Bruce V. Cartier, Washington Township, NJ (US)

Correspondence Address: Kenneth G. Lemke;Legal Division, Warner-Lambert Company, 201 Tabor Road, Morris Plains, NJ, 07950, US

(21) Appl. No.: 11/139,862

(22) Filed: May 27, 2005

Related U.S. Application Data
(60) Provisional application No. 60/574,795, filed on May 27, 2004.

(51) Int. Cl. F16B 45/02; B60R 22/12

(52) U.S. Cl. 24/599.1

(57) ABSTRACT

A carabiner for retaining an article includes a spine, a gate coupled to the spine, and a holder coupled to the spine configured to receive the article.

### FIELD

The present invention relates to a carabiner. The present invention more specifically relates to a carabiner having a holder, container or receptacle for receiving an article.

### BACKGROUND

A carabiner is a device, often associated with rock climbing or mountaineering, that allows for relatively quick and easy attachment (and/or release) with another article or object. Typical carabiners form a ring shape. The carabiner has a rigid portion (e.g., a spine) and a moveable portion (e.g., a gate) that interlock together to form the ring shape.

One known use for a carabiner is as a keychain. Keychains are known for storing or retaining keys. Typically, a keychain includes a ring for retaining or keeping keys together (such as a circular key ring) attached to a body, decorative article, fob, etc. A carabiner/keychain arrangement typically includes a key ring coupled to a carabiner. In a carabiner/keychain arrangement, the carabiner is attached to the key ring by first moving the gate to an open position, then providing the spine through the middle of the key ring, and then closing the gate (typically by allowing the gate to spring close).

Carabiners provide a desirable way to store and retain keys. However, it would be advantageous to provide a carabiner that provides for the storage and/or retention of other articles in addition to keys. It would be advantageous to utilize a carabiner to provide a platform for portable storage of articles such as containers, dispensers, vials, holders, etc. It would further be advantageous to provide easy access for a user to those articles.

It would be desirable to provide a carabiner that provides any one or more of these or other advantageous features.

### SUMMARY

The present invention relates to a carabiner for retaining an article. The carabiner includes a spine, a gate coupled to the spine, and a holder coupled to the spine configured to receive the article.

The present invention further relates to a keychain for holding an article. The keychain includes a carabiner, a key ring coupled to the carabiner, and a receptacle coupled to the carabiner for retaining the article.

The present invention further relates to an article comprising a ring having a moveable latch, and a holder coupled to the ring configured to receive and retain a second article

### BRIEF DESCRIPTION OF THE DRAWINGS

FIG. 1 is a front perspective view of a carabiner according to an exemplary embodiment.

FIG. 2 is a front perspective view of the carabiner shown in FIG. 1, showing a holder moving from a first position to a second position and a gate moving from a first position to a second position.

FIG. 3 is a rear perspective view of the carabiner shown in FIG. 1.

FIG. 4 is a front elevation view of the carabiner shown in FIG. 1.

FIG. 5 is a rear elevation view of the carabiner shown in FIG. 1.

FIG. 6 is a side elevation view of the carabiner shown in FIG. 1.

FIG. 7 is a top elevation view of the carabiner shown in FIG. 1 in a first position.

FIG. 8 is a top elevation view of the carabiner shown in FIG. 1 in a second position.

FIG. 9 is a front perspective view of a carabiner according to an exemplary embodiment.

FIG. 10 is a front elevation view of the carabiner shown in FIG. 9, showing a gate in a first position and a second position.

FIG. 11 is a rear perspective view of the carabiner shown in FIG. 9.

FIG. 12 is a side perspective view of the carabiner shown in FIG. 9.

FIG. 13 is a cross-section view of the carabiner shown in FIG. 10, taken along the line 13-13.

### DETAILED DESCRIPTION

Referring to the FIGURES, exemplary embodiments of a carabiner are shown. The carabiners shown in the exemplary embodiments provide selective storage, containment or retention of one or more articles at or near a carabiner. Furthermore, the carabiners shown may be used as key chains.

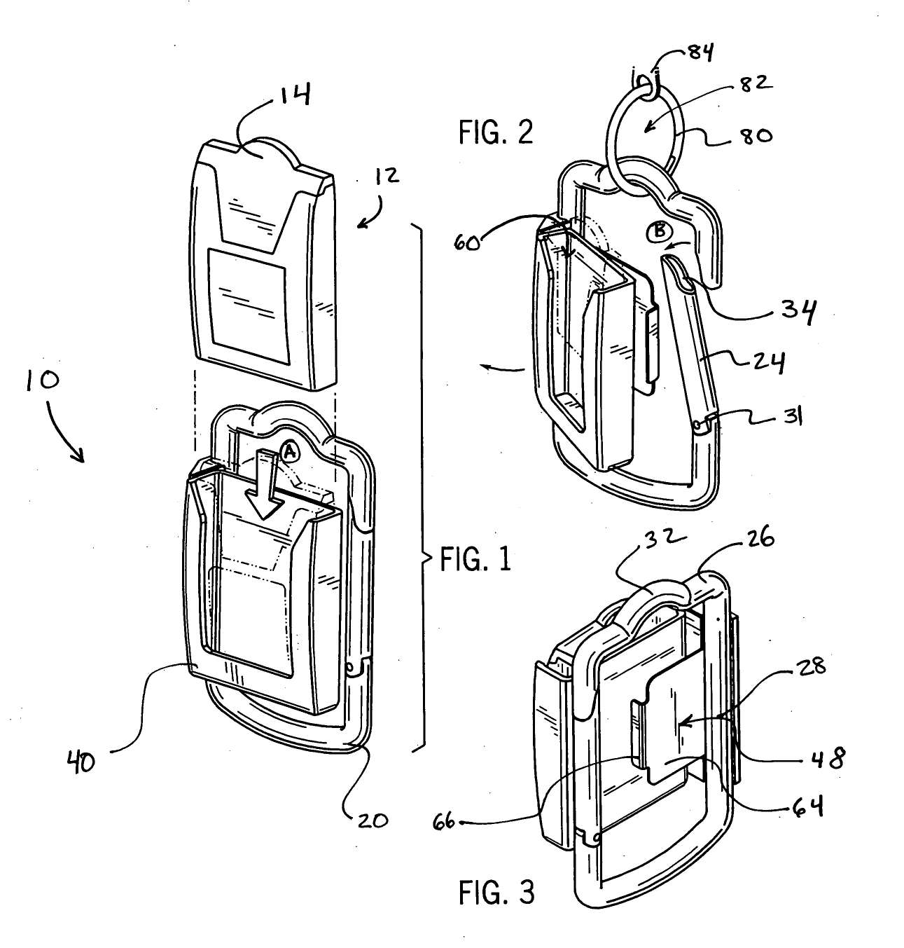

Referring to FIGS. 1 to 8, a carabiner 10 is shown that provides for the storage, containment, retention and/or selective removal of an article 12. Article 12 is shown as a vial as disclosed in U.S. Pat. No. D423,302 (VIAL FOR STORING AND DISPENSING FILMS issued Apr. 25, 2000 incorporated by reference herein) which preferable contains one or more films such as Listerine PocketPaks® oral care strips. However, article 12 is not limited to a vial as shown in the FIGURES. The article may be any of a wide variety of articles or objects (of which non-limiting examples are described herein).

As shown in FIG. 1, carabiner 10 comprises a ring 20 and a holder 40. Holder 40 is coupled to ring 20. Article 12 may be inserted (e.g., slidably received) into or within holder 40 as indicated by arrow “A”. Article 12 may be selectively stored, used and/or removed from carabiner 10.

As shown in FIGS. 2 and 3, ring 20 includes a spine 22 and a gate 24. According to a particularly preferred embodiment, spine 22 comprises a first portion 26 (shown as an upper, substantially horizontal portion in FIG. 3), a second portion 28 (shown as a vertical portion), and a third portion 30 (shown as a lower, substantially horizontal portion). According to a particularly preferred embodiment, portion 26 includes a curved or non-linear segment 32, portion 28 is substantially straight, and portion 30 has a generally curved shape. It should be noted that portions 26, 28 and 30 are denoted as separate elements for reference purposes. Portions 26, 28 and 30 may be integrally formed, one piece, separately formed and connected, or separate pieces. According to alternative embodiments, the ring may have a variety of shapes and configurations, such as a D-ring shape, S-ring shape, oval shape, pear shape, semi-circle shape, wire gate carabiners, bent gate carabiners, locking carabiners, etc. The spine may be a rigid portion, a fixed portion, a frame, a ring, a hook, etc. According to a particularly preferred embodiment, ring 20 is constructed from aluminum. Ring may be a carabiner, latch, hook, clip, etc.

Gate 24 is coupled to spine 22 at an end of portion 30 with a pin 31 (as shown in FIG. 2). A user may open gate 24 by applying a force to gate 24 in a direction indicated by arrow “B”, thereby rotating gate 24. A spring or other biasing mechanism (not shown) is provided to bias gate 24 from an open position (shown in FIG. 2) to a closed position (shown in FIG. 3). A free end 34 of gate 24 interfaces or coacts with an end of portion 26 to form a continuous loop or ring when gate 24 is in a closed position (as shown in FIG. 3). According to various exemplary embodiments, free end 34 and the end of portion 26 may have a variety of complimentary, interacting and/or locking shapes. The gate may also be referred to as a moveable portion, a latch, clip, etc.

A key ring 80 may optionally be provided. Key ring 80 is coupled to ring by opening gate 24, providing ring 20 through a central opening 82 in key ring 80, and closing gate 24. One or more keys (shown as fragment 84) may be coupled to key ring 80. According to various alternative embodiments, the key ring may be any of a wide variety of known fasteners or retainers associated with keys such as split-rings, clips, hooks, etc.

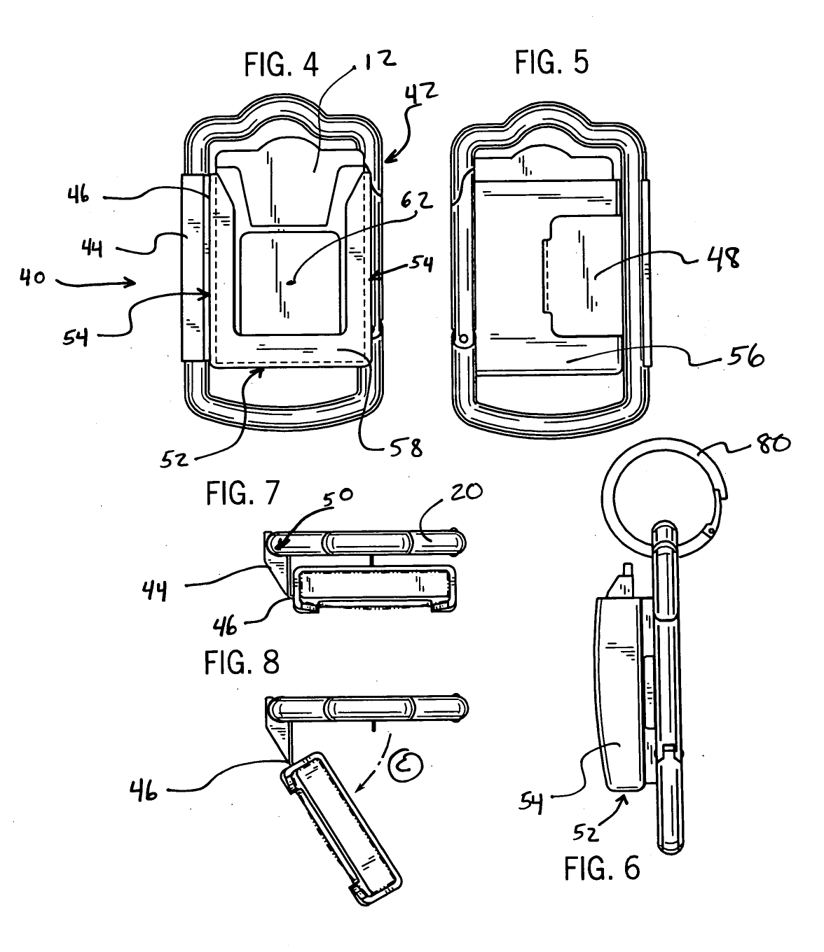

Referring to FIGS. 4-8, holder 40 is coupled to ring 20. Holder 40 is used to store, retain, and/or contain one or more articles on carabiner 10. According to an exemplary embodiment, article 12 is received within holder 40 and retained via a tension fit, a friction fit, or a snap fit. Alternatively, the article may be received into the holder and retained by a positive engagement such as a latch. Holder 40 may further coact with ribs or raised portions provided on the sides of article 12. The holder may also be a frame, support, retainer, receiver, etc.

Holder 40 comprises a frame 42, an arm 44, a hinge 46 provided between frame 42 and arm 44, and a support 48. According to a particularly preferred embodiment, holder 40 is coupled to portion 28 of ring 20. Holder 40 may be coupled to ring 20 using a variety of fastening mechanisms including mechanical fasteners, adhesives, welding, co-molding, “snap” or frictional engagements, etc. in a variety of different locations around the ring. According to a particularly preferred embodiment, arm 44 includes a portion 50 (such as a cut-out, socket, receiver, union, clip, radius, arc, claw, etc.) provided on an end of arm 44 (see FIG. 7). Portion 50 allows for a snap-fit or frictional engagement of arm 44 with ring 20. According to another particularly preferred embodiment, holder 40 is coupled to ring 20 with a sonic weld.

Hinge 46 is provided between arm 44 and frame 42. According to a particularly preferred embodiment, hinge 46 is a living hinge (e.g., a thin section of material (such as plastic) that connects arm 44 and frame 42 to keep them together and allow relative movement between arm 44 and frame 42). Hinge 46 may have a memory such that frame 42 is biased to return to a predetermined position or move in a certain direction. Alternatively, the hinge may have no memory (i.e., no biasing or returning force) and/or the hinge may have other configurations which allow for the relative movement between the arm and the frame (such as a pin-hinge, ball and socket, etc.). Alternatively, the hinge may be omitted, the arm and frame may be rigidly fixed with respect to each other. Furthermore, the arm and frame may optionally rotate around the spine.

Frame 42 is coupled to arm 44 via hinge 46. Frame 42 is configured to receive article 12. Frame 44 may be a holster, tray, slot, receiver, support, receptacle, sleeve, a member engaging the article with a friction fit, a box, a container, a container having a lid, and a member engaging the article with a positive engagement, etc. As shown in FIG. 4, frame 44 includes a bottom wall 52, two side walls 54, a back wall 56, a substantially open front wall 58 and an open top end 60 (see FIG. 2). Front wall 58 includes an open portion 62. As shown in FIG. 4, open portion 62 allows a user to see a portion of article 12 while article 12 is in a stowed position, allowing a user to identify the contents of article 12 in holder 40. Additionally, open portion 62 may allow for the use of article 12 while contained in holder 40. For example, as shown in FIG. 1, article 12 is shown as a vial as disclosed in U.S. Pat. No. D423,302 (VIAL FOR STORING AND DISPENSING FILMS issued Apr. 25, 2000) which preferable contain a film such as Listerine PocketPaks® oral care strips. Article 12 includes a hinged lid 14 which allows access to the films or strips contained in article 12. Lid 14 may be opened and closed (and the contents of article 12 accessed) while article 12 is received in holder 40. According to an alternative embodiment, the holder may have a closed front wall that does not allow the article to be accessed and/or used while received in the holder. According to other alternative embodiments, the holder may be a box, a receptacle, a receptacle having a hinged cover that must be opened in order to access the article, one or more hooks, a pouch, a pack, or any other structure configured to receive and retain an article.

Support 48 (as shown in FIGS. 3 and 5) projects into a middle portion of ring 20. According to an exemplary embodiment shown in FIG. 3, support 48 includes a planar element, member or extension (shown as member 64) and a projection 66 coupled in a substantially perpendicular direction to member 64.

As shown in FIG. 8, a user may rotate frame 42 in the direction indicated as arrow “C”. Once the user force is removed, hinge 46 may bias frame 42 toward the position shown in FIG. 7. Support 48 contacts frame 42 at projection 66 as frame 42 rotates back toward a rest position. Support 48 stops the rotation of frame 42 caused by hinge 46 at the position shown in FIGS. 6 and 7. According to an alternative embodiment, the support may be omitted. According to another alternative embodiment, the support may be omitted and a distal end of the frame may contact the ring to stop rotation caused by the hinge. Alternatively, the holder may be rigid in construction such that the frame does not rotate and the support is not provided. According to an alternative embodiment, a locking mechanism (such as a latch on the free end of the frame) may be provided to lock or prevent movement when force is not applied by a user, thereby allowing for user selected movement of the frame.

Holder 40 may be provided with ridges, projections, raised or textured surfaces, or protrusions along the sides of the holder to assist a user in gripping carabiner 10, or to assist in removal of article 12. According to a particularly preferred embodiment, holder 40 is a single unit constructed from injection molded plastic (such as polypropylene or polyethylene). Alternatively, the holder may be constructed and assembled from multiple pieces.

Carabiner 10 advantageously provides a support, frame or platform to receive and store an article near carabiner 10. Carabiner 10 also advantageously provides for convenient attachment to and use while attached to other objects. Gate 24 of carabiner 10 allows for quick attachment. When in a hanging position, portions 30 and 32 center or orient objects attached to the carabiner, relative to the carabiner (such as key ring 80, or a belt loop or other attachment point). Additionally, key ring 80 is free to move around a substantial length of ring 20 and thereby be easily reoriented.

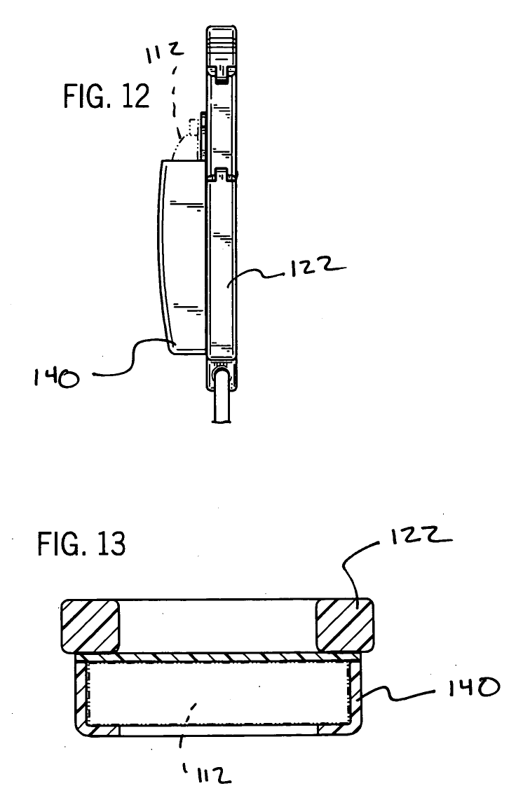

Referring to FIGS. 9 to 13, a carabiner 100 is shown according to another exemplary embodiment. Carabiner 100 comprises a ring 120 and a holder 140. Holder 140 is coupled to ring 120. Article 112 may be inserted into holder 140 as described above. Accordingly, article 112 may be selectively stored, used and/or removed from carabiner 110.

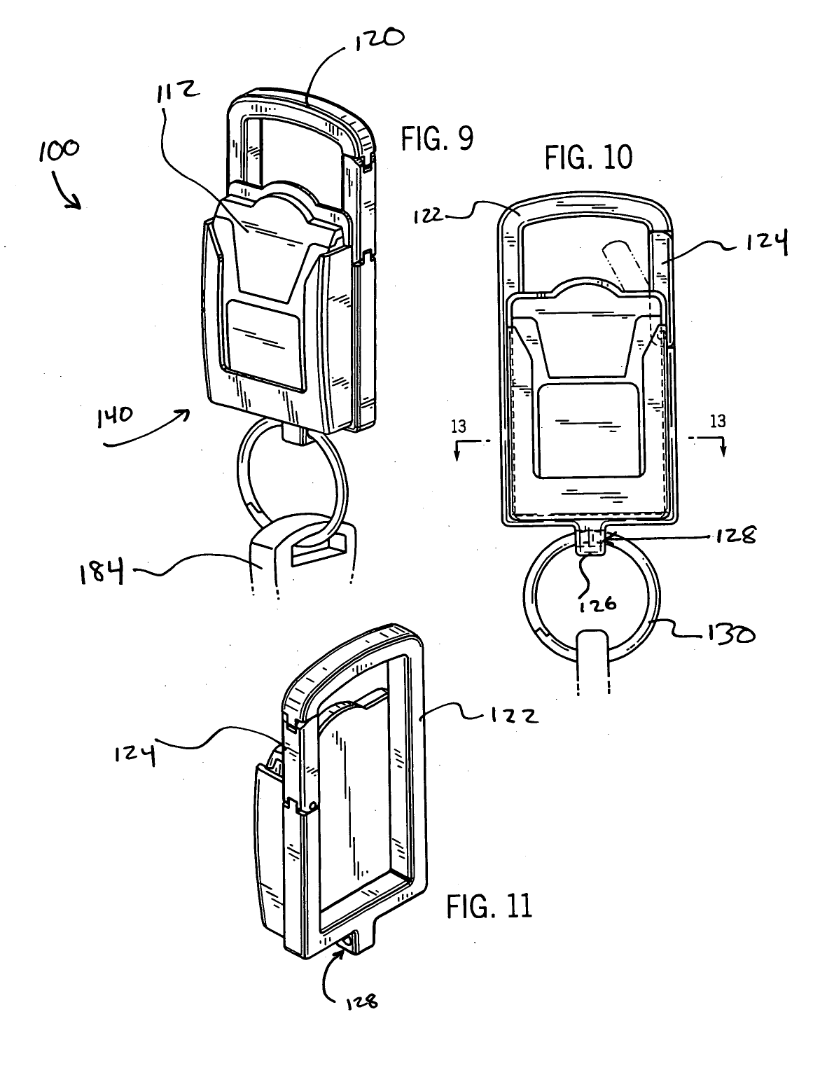

Ring 120 has an overall similar arrangement and construction as ring 20, including comprising a spine 122 and a gate 124. According to various exemplary embodiments, ring 120 may be constructed from a variety of materials including metal, steel, aluminum, plastics, polymers, etc. As shown in FIGS. 9 and 10, ring 120 may further comprise a projection 126 provided on lower portion of ring 120. An aperture 128 is provided through projection 126. As shown in FIG. 10, a key ring 130 may be provided through aperture 128 to receive one or more keys 184.

Holder 140 is preferably rigidly coupled to spine 122. According to a particularly preferred embodiment, holder is coupled to spine with an adhesive bond. According to another particularly preferred embodiment, holder 140 includes projections (not shown) provided on a back side that fit into corresponding apertures provided in the spine (not shown) and is held in place by a friction fit. According to another particularly preferred embodiment, holder 140 is coupled to spine via a heat-staking process. Holder 140 may be constructed from a variety of materials including plastics, polymers, styrene, ABS, etc.

Advantageously, holder 140 provides a rigid support or frame to receive an article with respect to ring 120.

It is important to note that the construction and arrangement of the elements of the carabiner as shown in the exemplary, particularly preferred and alternative embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements show as multiple parts may be integrally formed, the operation of the interface of the members of the carabiner may be reversed or otherwise varied, the length or width of the elements of the system may be varied, etc. The article may be any of a variety of objects, packages, boxes, containers, parts, units, blisters, packages, vials, containers, pills, tablets, mints, gums, candies, films, consumables, dispenser, portable film pack, an oral care product, coins, string, accessories, chalk, webbing, climbing equipment, bits, parts, nuts, screws, etc. It should be noted that the elements and/or assemblies of the system may be constructed from any of a wide variety of materials that provide sufficient strength or durability, including any of a wide variety of moldable plastic materials (such as high-impact plastic) in any of a wide variety of colors, textures and combinations, metals and composites. The carabiner may or may not be used as a key chain, and/or with or without a key ring. Accordingly, all such modifications are intended to be included within the scope of the present inventions. Other substitutions, modifications, changes and omissions may be made in the design, operating conditions and arrangement of the preferred and other exemplary embodiments without departing from the spirit of the present invention.

1. A carabiner for retaining an article, the carabiner comprising:
a spine;
a gate coupled to the spine; and
a holder coupled to the spine configured to removably receive the article.

2. The carabiner of claim 1 wherein the holder comprises at least one of a holster, a receptacle, a sleeve, a member engaging the article with a friction fit, a box, a container, a container having a lid, and a member engaging the article with a positive engagement.

3. The carabiner of claim 1 further comprising the article.

4. The carabiner of claim 3 wherein the article comprises at least one of a container, a vial, a dispenser, a portable film pack, an oral care product, a gum, a candy, and a consumable film.

5. The carabiner of claim 1 wherein the article is configured to be received within the holder.

6. The carabiner of claim 1 wherein the holder is rigidly coupled to the spine.

7. The carabiner of claim 1 wherein the holder is movably coupled to the spine.

8. The carabiner of claim 7 wherein the holder being movably coupled to the carabiner further comprises at least one of rotatably coupled and hingedly coupled.

9. The carabiner of claim 7 wherein the holder is movable from a first position to a second position.

10. The carabiner of claim 9 wherein the holder engages the carabiner in the first position such that the holder is not freely movable from the first position to the second position.

11. The carabiner of claim 1 wherein the holder is configured to allow access or use of the article while the article is retained in the holder.

12. The carabiner of claim 1 further comprising a key ring.

13. A keychain for holding an article comprising:
a carabiner;
a key ring coupled to the carabiner; and
a receptacle coupled to the carabiner for retaining the article.

14. The keychain of claim 13 wherein the receptacle comprises two side walls, a bottom wall, a back wall and a front wall.

15. The keychain of claim 14 wherein the front wall has an open portion configured to allow opening of the article when the article is retained in the receptacle.

16. The keychain of claim 13 wherein the article is slidably received in the receptacle.

17. An article comprising;
a ring having a moveable latch; and
a holder coupled to the ring configured to receive and retain a second article.

18. The article of claim 17 wherein the ring further comprises a carabiner.

19. The article of claim 17 further comprising a key ring attached to the ring.

20. The article of claim 17 wherein the holder is at least one of rigidly fixed and moveable.
